(19) United States
(12) Patent Application Publication
(10) Pub. No.: US 2020/0045389 A1
(43) Pub. Date: Feb. 6, 2020

(54) SYSTEM FOR DISTRIBUTED MONITORING OF PERTURBATION IN GIGABIT PASSIVE OPTICAL NETWORK (GPON) ARCHITECTURE AND METHOD THEREOF

(71) Applicant: TELEKOM MALAYSIA BERHAD, Kuala Lumpur (MY)

(72) Inventors: Farha Binti MASKURIY, Shah Alam (MY); Tee Din CHAI, Klang (MY); Muhammad Lukman Hadi JAMALUDIN, Bandar Baru Salak Tinggi (MY); Zainuddin Bin LAMBAK, Kuala Terengganu (MY); Fong Kok HANN, Kuala Lumpur (MY)

(73) Assignee: TELEKOM MALAYSIA BERHAD, Kuala Lumpur (MY)

(21) Appl. No.: 16/527,660

(22) Filed: Jul. 31, 2019

(30) Foreign Application Priority Data
Jul. 31, 2018 (MY) PI 2018702668

(51) Int. Cl. H04Q 11/00; H04J 14/02; G01D 5/353; G01K 11/32

(52) U.S. Cl. CPC H04Q 11/0067; H04J 14/023; G01D 5/35364; H04Q 2011/0083; G01K 2011/322; H04Q 2011/0088; G01K 11/32

(57) ABSTRACT

The present invention relates to a system and method for distributed monitoring of perturbation in Gigabit Passive Optical Network (GPON) architecture. The system based on Brillouin Optical Time Domain Analysis (BOTDA) includes a BOTDA module; where in the module includes signal source module, an optical circulator connected to a Wavelength Division Multiplexer (WDM); a wavelength reflector deployed near to an Optical Network Unit (ONU) along the optical fiber line; a photodetector connected to the optical circulator; and a signal processing module.

### CROSS-REFERENCE TO RELATED APPLICATION

This application is a national application claiming priority benefit to Malaysia Patent Application PI 2018702668, filed on Jul. 31, 2018. The entire contents and disclosures of the above application are incorporated herein by reference.

### FIELD OF THE INVENTION

The present invention relates generally to fiber monitoring and sensing system. More particularly, the present invention relates to distributed monitoring and sensing heat and strain system for use in gigabit passive optical network (GPON) architecture.

### BACKGROUND OF THE INVENTION

Fiber to the home (FTTH) is a complete deployment of fiber to customers' home, with replacement of the existing Network Interface Device (NID). This replacement is called an ONU (Optical Network Unit). The ONU converts fiber-optic light signals to copper or electric signals. FTTH broadband connections refer to fiber optic cable connections for individual residences. Such optics-based systems can deliver a multitude of digital information such as telephone, video, and data more efficiently than traditional copper coaxial cable for about the same price.

Gigabit Passive Optical Network (GPON) is an evolutionary technology based upon Broadband Passive Optical Network (BPON). It supports higher rates, enhanced security, and choice of Layer 2 protocol (ATM, GEM, Ethernet). GPON uses IP-based protocols to transfer data. In GPON system, all fiber is connected along the way from the central office, to the home users. Its main characteristic is the use of passive splitters in the fiber distribution network, enabling one single feeding fiber from the provider's central office to serve multiple homes and small businesses.

It is important in today's fiber optic communication transmission medium not only to transmit optical communication signal, but also to have sensing functionality for high-sensitivity detection of a parameters along the fiber network. Distributed fiber optic sensing presents unique features that have no match in conventional sensing technique. The ability to measure temperatures and strain at thousands of points along a single fiber is particularly interesting for the monitoring of large structures. Unlike electrical and localized fiber optic sensors, distributed sensor offers characteristic of being able to measure physical parameters along its fiber length, allowing measurement of thousands of points using a single transducer.

The most developed technologies of distributed fiber optic sensors are based on Raman and Brillouin scattering. Both systems make use of a non-linear interaction between the light and the silica material of which the fiber is made. If light at a known wavelength is launched into a fiber, a very small amount of it is scattered back every point along the fiber. The scattered light contains components at wavelengths that are different from the original signal. These shifted components contain information on the local properties of the fiber, in particular their strain and temperature.

Improvement of existing fiber system in a passive network architecture can be done by integrating an Optical Time Domain Reflectometer (OTDR) to establish a centralized sensing system. However, this technique requires extra component interferometer (IF) unit to be installed at customer premise. To cover large area of detection, multiple IF unit need to be installed at different location, increasing complexity and cost. Thus, maximizing features of the existing network architecture will allow for additional services. Accordingly, it is an object of the present invention to overcome or at least ameliorate one or more of the disadvantages of the prior art.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

Accordingly, the present invention provides a system for distributed monitoring of perturbation in Gigabit Passive Optical Network (GPON) architecture.

The system of the present invention which is based on Brillouin Optical Time Domain Analysis (BOTDA) may be characterized by the system comprises a signal source module comprising fiber path ports each configured for generating a multi-wavelength sensing signal, wherein the multi-wavelength sensing signal includes a first sensing signal and a second sensing signal produced by the signal source module, each transmitted at different predetermined transmitting periods; wherein the second sensing signal is subject to stimulated Brillouin scattering to generate a backscattered sensing signal; an optical circulator connected to a Wavelength Division Multiplexer, WDM, for circulating the first sensing signal (101a) to a GPON architecture, wherein the WDM combines the first sensing signal with a data signal generated by an Optical Line Terminal, OLT for producing a combined signal; wherein the combined signal is guided within the GPON architecture through an optical fiber line; a wavelength reflector deployed near to an Optical Network Unit, ONU, along the optical fiber line for reflecting the first sensing signal in an opposite direction into the optical fiber line and for allowing only the data signal to the ONU, wherein the data signal is redirected back to the OLT; a photodetector connected to the optical circulator for receiving a reflected sensing signal and the backscattered sensing signal, wherein the reflected sensing signal and the backscattered sensing signal are converted to a digital sensing signal by a signal digitizer; and a signal processing module is analyzing the digital sensing signal received from the signal digitizer to determine the perturbation thereof, wherein the perturbation includes heat and strain.

Preferably, the signal source module (101c) comprises two fiber path ports being coupled into a fiber cable by an optical combiner (102)

Preferably, the multi-wavelength sensing signal (101a) has a wavelength that corresponds to that of the wavelength reflector (109).

Preferably, the first sensing signal is a probe signal.

Preferably, the second sensing signal is a pump signal.

Preferably, the first sensing signal and the second sensing signal is continuous wave (CVV) source and pulse source respectively.

Preferably, the first sensing signal (101a) frequency that is computed as an initial signal frequency, fₒ−fB.

Preferably, fB is the Brillouin shift of the optical fiber line (107).

Preferably, the second sensing signal is computed as an initial signal frequency, fₒ.

Preferably, the second sensing signal (101b) is transmitted after the first sensing signal (101a) is reflected back by the wavelength reflector (109).

In accordance with another aspect of the present invention, a method for distributed monitoring of perturbation in GPON architecture, which is based on BOTDA is provided.

The method can be characterized by the steps of generating a multi-wavelength sensing signal, wherein the multi-wavelength sensing signal includes a first sensing signal and a second sensing signal produced by the signal source module, each transmitted at different predetermined transmitting periods; wherein the second sensing signal is subject to stimulated Brillouin scattering to generate a backscattered sensing signal; circulating the first sensing signal to a GPON architecture, wherein the WDM combines the first sensing signal with a data signal generated by an Optical Line Terminal, OLT for producing a combined signal; wherein the combined signal is guided within the GPON architecture through an optical fiber line; reflecting the first sensing signal in an opposite direction into the optical fiber line and for allowing only the data signal to the ONU, wherein the data signal is redirected back to the OLT; receiving a reflected sensing signal transmitted from the wavelength reflector and a backscattered sensing signal wherein the reflected sensing signal and the backscattered sensing signal are converted to a digital sensing signal by a signal digitizer; analyzing the digital sensing signal received from the signal digitizer to determine the perturbation thereof, wherein the perturbation includes heat and strain.

It is therefore an advantage of the present invention that improves and enhances the services provided in GPON architecture by fully utilizing the existing fiber system network, and optimizing the components and infrastructure of the fiber network.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

A more complete appreciation of the invention and many of the attendant advantages thereof will be readily as the same becomes better understood by reference to the following detailed description when considered in connection with the accompanying drawings, wherein:

FIG. 1 illustrates the distributed monitoring and sensing heat and strain system according to one embodiment of the present invention;

FIG. 2 illustrates the architecture of a conventional GPON system with optical splitters arrangement of the present invention according to one embodiment of the present invention;

FIG. 3 illustrates the output configuration of the final splitter according to one embodiment of the present invention;

FIG. 4 illustrates the existing GPON architecture installed with the system of the present invention using a dark fiber network according to one embodiment of the present invention;

FIG. 5 shows sub flow chart of the BOTDA module in GPON network in terms of signal transmission time according to another preferred embodiment of the present invention; and

FIG. 6 shows process flow chart of the monitoring and sensing process according to another preferred embodiment of the present invention.

It is noted that the drawings may not be to scale. The drawings are intended to depict only typical aspects of the invention, and therefore should not be considered as limiting the scope of the invention. In the drawings, like numberings represent like elements between the drawings.

### DETAILED DESCRIPTION OF THE INVENTION

It is an object of the present invention to provide a system for distributed monitoring and sensing heat and strain system for use in gigabit passive optical network (GPON) architecture. The present invention advantageously offers a more desirable alternative approach of maximizing existing fiber system network and optimizing components and infrastructure of the fiber network in a GPON architecture. By deploying a Brillouin Optical Time Domain Analysis (BOTDA) to the existing infrastructure, users will only need to add in minimal cost for additional sensing services in their premises.

The present invention relates to a technique of sensing heat and strain in the existing of GPON architecture by manipulating the intrinsic behavior of the fiber optic. It uses the behavior of Brillouin Scattering in the fiber optic for heat and strain detection. The BOTDA module interrogates variables of any perturbation along a sensing fiber in the GPON network through the power evolution of the sensing signals.

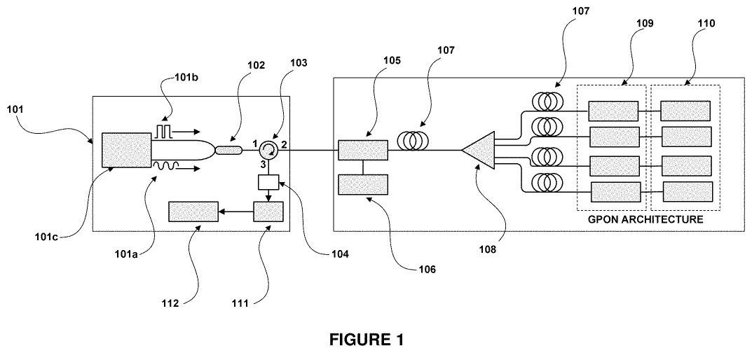

The system of the present invention includes a BOTDA module 101 comprises a signal source module 101c, an additional optical combiner 102, an optical circulator 103, a photodetector 104, a signal digitizer 111, and a signal processing module 112. A GPON network architecture comprises a Wavelength Division Multiplexer (WDM) 105 connected to an Optical Line Terminal (OLT) 106 along an optical fiber line 107 which is splitted by an optical splitter 108 into a given number of fibers network leaving the splitter. Each fiber network is connected with at least a wavelength reflector (WR) 109 and an Optical Network Unit (ONU) 110 at the user end premise as shown in FIG. 1.

The signal source module 101c in the BOTDA module 101 comprises two fiber path ports coupled into a fiber cable by an optical combiner 102 so that the BOTDA module 101 will act like sending sensing signals with only one port to the GPON network. The signal source module 101c is configured for generating a multi-wavelength sensing signal 101a, 101b. These sensing signals 101a, 101b are transmitted at different predetermined time and will be propagated towards the ONU 110. The initial signal transmitted by the fiber path port is the first sensing signal (herein after “Signal A”) 101a and the next signal transmitted is the second sensing signal (herein after “Signal B”) 101b. These multi-wavelength sensing signals 101a, 101b consist of probe signal and pump signal, which are generated by a Continuous Wave (CVV) source or a pulse source at any single time (probe signal and pump signal cannot be of the same signal type).

The wavelength configurations of these sensing signals 101a, 101b are corresponds to the conditions below:
i) WR 109 (either standalone or with ONU 110) with unique central wavelength. The multi-wavelength sensing signals 101a, 101b is frequency-swept sequentially according to the reflected frequency range of the corresponding WR 109.
ii) The BOTDA module 101 is sending different wavelengths for each ONU 110 in sequentially pattern from one ONU 110 to another.
iii) After completed monitoring for, the first transmission, wavelength of the sensing signals is switched to another wavelength.

The optical circulator 103 is to circulating Signal A 101a to the GPON architecture through the WDM 105, whereby the WDM 105 combines Signal A 101a with data signal generated by an OLT 106 producing a combined signal. The combined signal is the input of an optical fiber line 107. GPON uses WDM 105 so a single fiber can be used for both downstream and upstream data signal. A laser on a wavelength (λ) of 1490 nm (E band) transmits downstream data signal. Upstream data signal transmits on a wavelength of 1310 nm (0 Band). In another preferred embodiment of the present invention, the multi-wavelength sensing signals used are in the 1550 nm region (C Band). The sensing signals can be in other optical band except O and E band.

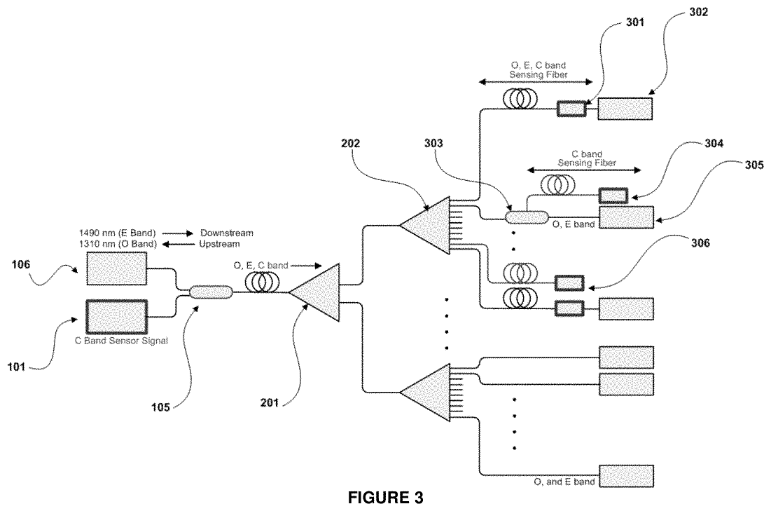

During sensing process, Signal A 101a will be reflected back to its opposite direction by the WR 109. At the same time, the WR 109 allows for data signal to pass to the ONU 110. This however, is also depending on the network configuration as illustrated in FIG. 3. Alternatively, WR 109 can be a fiber Bragg grating (FBG) reflector or a mirror. While reflected Signal A 101a propagates back towards the optical circulator 103, Signal B 101b will be transmitted from another fiber path port. Signal B 101b will undergo Brillouin scattering and backscattered to a lower frequency, therefore backscattered Signal B 101b will then be in the same propagation direction with the reflected Signal A 101a. The reflected signal A 101a and the backscattered signal B 101b propagates back and detected by the photodetector 104. The combined reflected signal A and backscattered signal B is then digitized by a signal digitizer 111; the digitized signal is then received by a signal processing module 112 to determine the perturbation. Amplification of the Signal A 101a indicates strains or temperature detection in the sensing fiber.

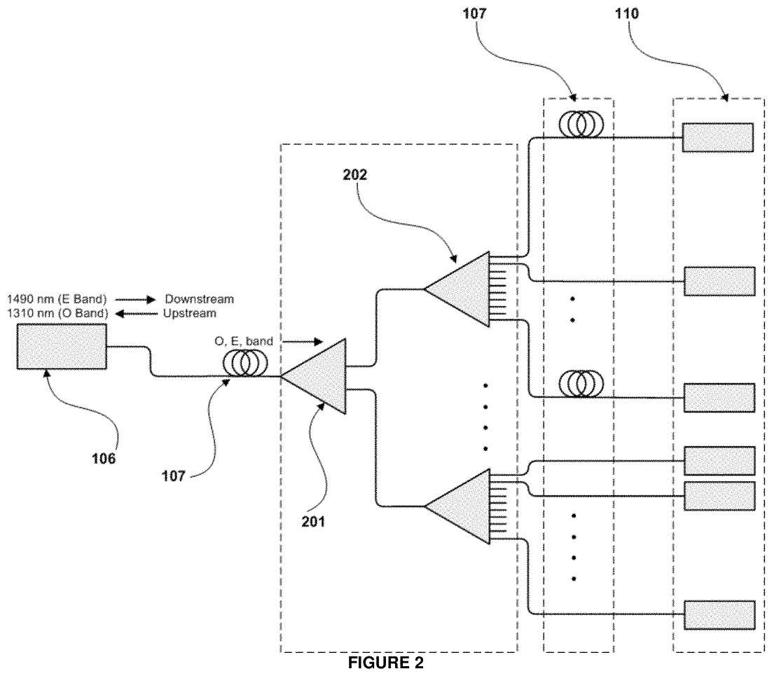

In another embodiment of the present invention, output of WDM 105 is directed into optical splitter 108. The optical splitter 108 can consists of M outputs by 1×M splitter 201. Each output of the M splitter 201 may again be split subsequently by another 1×N 202 if any. The typical split of a single fiber is 1:32 or 1:64. That means each fiber can serve up to 32 or 64 subscribers. Split ratios up to 1:128 are possible in some systems. The present invention is bounded to the sensitivity limitation of the BOTDA module 101—the arrangement of the optical splitter 108 of the present invention is shown by FIG. 2.

FIG. 3 illustrates configuration of the combined signal of Signal A and data signal at the output of the final splitter 202 are as below:
i) Signal A will be reflected by the WR 301 meanwhile data signal will pass through first WR 301 into the first ONU 302.
ii) Data signal and Signal A will be split by a second WDM 303 where Signal A will be reflected by the second WR 304 and the data signal will be sent to the second ONU 305.
iii) Signal A will be reflected by third WR 306. Since there is no any ONU 110 involved at the end, data signal is then terminated.

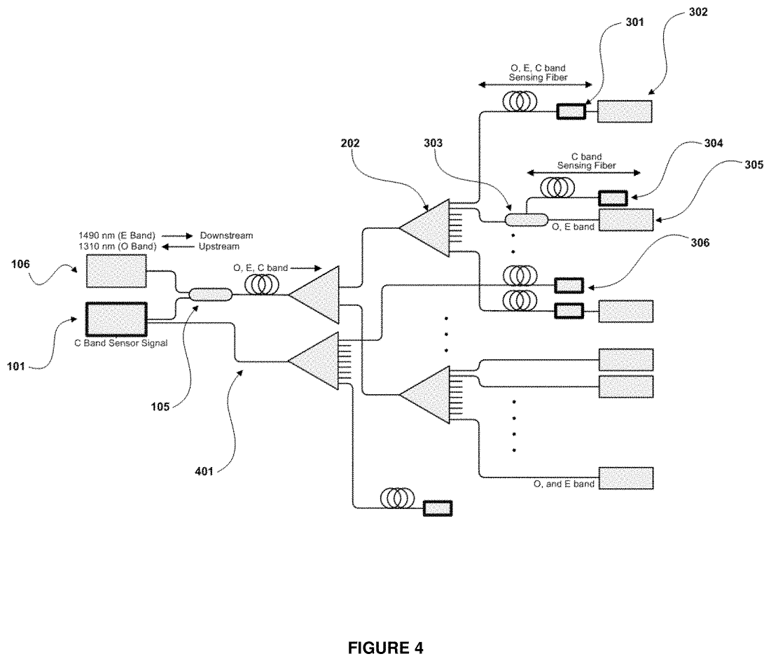

In another preferred embodiment of the present invention, for fiber link channel with poor power link budget, the system of the present invention can be implemented through dark fiber network architecture while for good power link budget fiber channel, system of the present invention are coupled into the data or service channel. FIG. 4 illustrates the of existing GPON architecture installed with the system of the present invention using a dark fiber network 401.

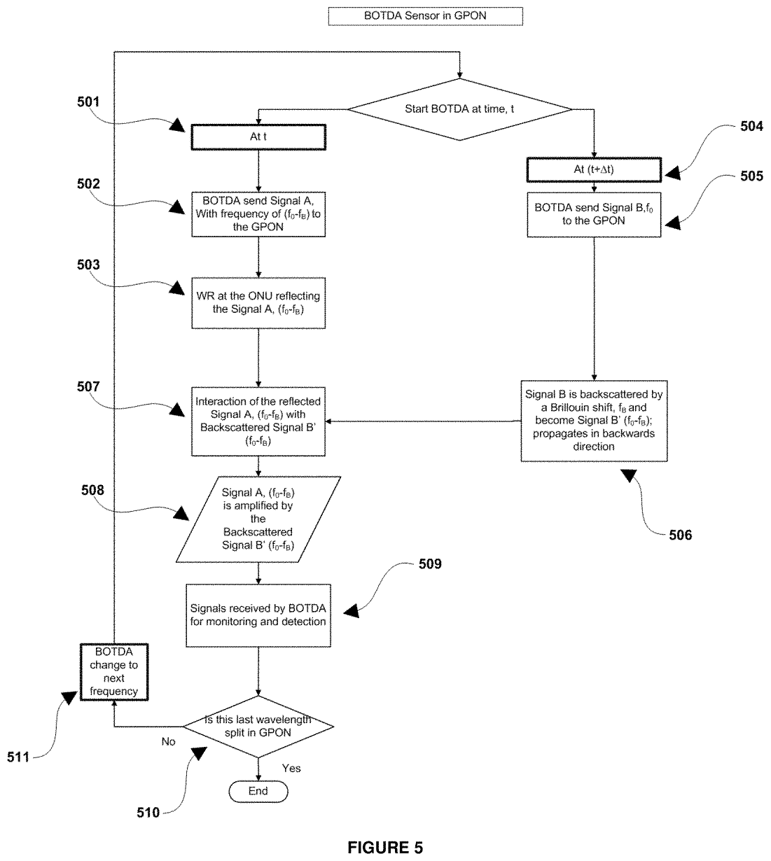

FIG. 5 is an exemplary sub flow chart of the BOTDA module 101 in GPON network in terms of signal transmission time according to another preferred embodiment of the present invention. The sensing of any pertubation starts at the WDM 105 to the first ONU 302, at time t, as in the step 501. The frequency of the Signal A 101a is set at (fₒ−fB), where fB is the Brillouin shift of the fiber; as in the step 502 before transmitting to the GPON network. The first WR 301 receive Signal A 101a and reflects back the signal to the photodiode 104 as in step 503. While Signal A is still propagating towards the PD in the BOTDA module 101, at t+Δt (as in step 504), the signal source module 101c transmit Signal B 101b with frequency set at (fₒ), to the first ONU 302 as in step 505. Whenever there is strain, or temperature changes, Signal B 101b will detect them and shifts its frequency to a lower frequency by fB, becomes (fₒ−fB) following step 506, and travel backward with same direction of the reflected Signal A 101a, towards the PD 104 in the BOTDA module 101. Interaction of the reflected Signal A 101a, (fₒ−fB) with backscattered Signal B′ (fₒ−fB) in step 507 happens where this reflected Signal A 101a (fₒ−fB) will be amplified in step 508 by the backscattered Signal B′ (fₒ−fB). Then, at step 509, the amplified signal will be received by the BOTDA module 101 for monitoring and detection. The monitoring and detection will be continued by sending a second Signal A at time t2 with different frequency as in step 510 and 511 to the second ONU 305.

It should be noted that due to the property of the WR 109 which may reflect a range of frequency, Signal A may also take a form of a range of frequency which is achieved by sweeping the frequency of Signal A within the reflected frequency range of the WR 109. For example, a feedback loop between steps 501 and 509 can be added to sweep the frequency of Signal A, such that it covers the whole reflecting range of WR 109 before going forward to step 510.

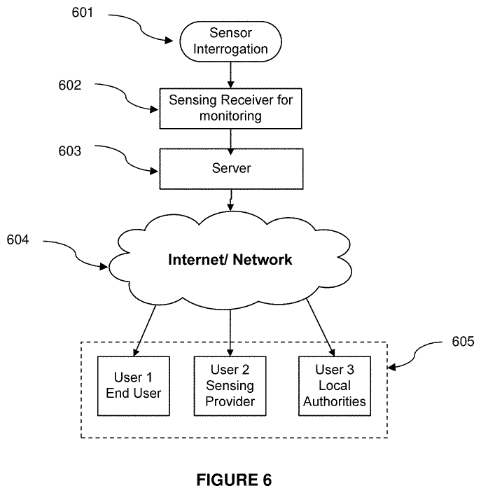

FIG. 6 shows an exemplary of process flow chart of the monitoring and sensing process according to another preferred embodiment of the present invention. Sensor interrogation in step 601 refers to the process of sending sensing signal to the sensing fiber in the end user's premise and the process of the back-scattering sensing signal and Brillouin frequency shift if there is any changes in term of power evolution due to any of temperature and strain detection. The next step 602 the sensing receiver for monitoring part handles the processed sensing signal after detecting the perturbation in the fiber. Any detection of perturbation in the fiber, the system will generate warning alarm to central server for urgent notification. Then at step 603, the system of the present invention includes a server comprises user database, GPS and map location for each user. It also contains previous history to identify fault alarm probability and reduces fault alarm. This part is the intelligent section to process and identify which specific user's premise is correspond to the detection of the sensing signal. It also has the ability to give alert to specific user through the internet or local network for step 604 which includes SMS, phone call and mobile application platforms. These three platforms are used to deliver the warning alert to specific user and all related person. Finally, at step 605 user of the system can be any of the related person to the corresponding transmission line depending on what application the sensor is used for.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

While this invention has been particularly shown and described with reference to the exemplary embodiments thereof, it will be understood by those skilled in the art that various changes in form and details may be made therein without departing from the scope of the invention as defined by the appended claims.

What is claimed is:

1. A system for distributed monitoring of perturbation in Gigabit Passive Optical Network, GPON, architecture, characterized in that, the system which is based on Brillouin Optical Time Domain Analysis, BOTDA, comprising:
a signal source module comprising fiber path ports each configured for generating a multi-wavelength sensing signal,
wherein the multi-wavelength sensing signal includes a first sensing signal and a second sensing signal produced by the signal source module, each transmitted at different predetermined transmitting periods;
wherein the second sensing signal is subject to stimulated Brillouin scattering to generate a backscattered sensing signal;
an optical circulator connected to a Wavelength Division Multiplexer, WDM, for circulating the first sensing signal to a GPON architecture,
wherein the WDM combines the first sensing signal with a data signal generated by an Optical Line Terminal, OLT for producing a combined signal;
wherein the combined signal is guided within the GPON architecture through an optical fiber line;
a wavelength reflector deployed near an Optical Network Unit, ONU, along the optical fiber line for reflecting the first sensing signal in an opposite direction into the optical fiber line and for allowing only the data signal to the ONU, wherein the data signal is redirected back to the OLT;
a photodetector connected to the optical circulator for receiving reflected sensing signal from wavelength reflector and backscattered sensing signal, wherein the reflected sensing signal and the backscattered sensing signal are converted to a digital sensing signal by a signal digitizer;
a signal processing module for analyzing the digital sensing signal received from the signal digitizer to determine the perturbation thereof, wherein the perturbation includes heat and strain.

2. The system according to claim 1, wherein the signal source module comprises two fiber path ports being coupled into a fiber cable by an optical combiner.

3. The system according to claim 1, wherein the multi-wavelength sensing signal has a wavelength that corresponds to that of the wavelength reflector.

4. The system according to claim 1, wherein the first sensing signal is a probe signal.

5. The system according to claim 1, wherein the second sensing signal is a pump signal.

6. The system according to claim 1, wherein the first sensing signal and the second sensing signal is continuous wave (CVV) source and pulse source respectively,
wherein the first sensing signal is a probe signal; and
wherein the second sensing signal is a pump signal.

7. The system according to claim 1, wherein the first sensing signal frequency that is computed as an initial signal frequency, fₒ−fB.

8. The system according to claim 7, wherein fB is the Brillouin shift of the optical fiber line.

9. The system according to claim 1, wherein the second sensing signal is computed as an initial signal frequency, fₒ.

10. The system according to claim 1, wherein the second sensing signal is transmitted after the first sensing signal is reflected back by the wavelength reflector.

11. A method for distributed monitoring of perturbation in Gigabit Passive Optical Network, GPON, architecture, characterized in that, the system which is based on Brillouin Optical Time Domain Analysis, BOTDA, comprising the steps of:
generating a multi-wavelength sensing signal,
wherein the multi-wavelength sensing signal includes a first sensing signal and a second sensing signal produced by the signal source module, each transmitted at different predetermined transmitting periods;
wherein the second sensing signal is subject to stimulated Brillouin scattering to generate a backscattered sensing signal;
circulating the first sensing signal to a GPON architecture,
wherein the WDM combines the first sensing signal with a data signal generated by an Optical Line Terminal, OLT for producing a combined signal;
wherein the combined signal is guided within the GPON architecture through an optical fiber line;
reflecting the first sensing signal in an opposite direction into the optical fiber line and for allowing only the data signal to the ONU, wherein the data signal is redirected back to the OLT;
receiving a reflected sensing signal transmitted from the wavelength reflector and a backscattered sensing signal wherein the reflected sensing signal and the backscattered sensing signal are converted to a digital sensing signal by a signal digitizer.
analyzing the digital sensing signal received from the signal digitizer to determine the perturbation thereof, wherein the perturbation includes heat and strain.
